(19) United States
(12) Patent Application Publication
(10) Pub. No.: US 2003/0197076 A1
(43) Pub. Date: Oct. 23, 2003

(54) Coating material supply nozzle

(75) Inventors: Toshiro Iwamoto, Ebina-shi (JP); Hiroshi Miyamura, Ebina-shi (JP); Takashi Iwasaki, Ebina-shi (JP); Yoshinari Yasui, Ebina-shi (JP)

Correspondence Address: Koda & Androlia, Suite 3850, 2029 Century Park East, Los Angeles, CA, 90067, US

(73) Assignee: Yasui Seiki Co., Ltd.

(21) Appl. No.: 10/321,168

(22) Filed: Dec. 17, 2002

(30) Foreign Application Priority Data
Dec. 20, 2001 (JP) 2001-387986

(51) Int. Cl. B05B 9/03

(52) U.S. Cl. 239/597; 239/598; 239/601; 239/302

(57) ABSTRACT

A coating material supply nozzle has a coating material reservoir where a coating material fed from the outside into a nozzle body, and an elongated nozzle port, from which the coating material passed through a nozzle passage is discharged. A coating material feed pipe for feeding the coating material is mounted in the coating material supply nozzle to extend in said coating material reservoir over the entire length. The coating material feed pipe is provided with at least one coating material feed bore for guiding the coating material within the coating material feed pipe into the coating material reservoir uniformly in a lengthwise direction of the coating material reservoir.

### BACKGROUND OF THE INVENTION

1. Field of the Invention

The present invention relates to a coating material supply nozzle capable of appropriately supplying a coating material to a traveling substrate.

1. Description of the Related Art

Conventionally, a coating material supply nozzle having an elongated nozzle port has been used in many cases as a device for coating a coating material onto a substrate comprising a resinous film, a sheet of paper, a fabric or the like. This coating material supply nozzle is disposed in such a manner that a nozzle port provided there in faces to a continuous substrate delivered from a raw-substrate roll to travel, so that a predetermined coating material is discharged from the nozzle port and applied onto a surface of the substrate.

FIGS. 12 and 13 shows a prior art example 1 of such a conventional coating material supply nozzle. This coating material supply nozzle 20 has a nozzle body 21 comprising a longer nozzle half 22 on a front side and a nozzle half 23 on a back side, which are integrally coupled to each other by a bolt 24. A side enclosure 28 is secured to each of the front-side nozzle half 22 and the back-side nozzle half 23 coupled to each other. A joint surface of the front-side nozzle half 22 is formed into a flat shape, and a coating material reservoir 25 semicircular in section is defined in a joint surface of the back-side nozzle half 23 at a location intermediate in a direction of the height thereof to extend in a lengthwise direction.

Further, the back-side nozzle half 23 is formed, so that the thickness of an upper portion above the coating material reservoir 25 is slightly smaller than the thickness of a lower portion below the coating material reservoir 25. In a state in which the front-side nozzle half 22 and the back-side nozzle half 23 have been coupled to each other, a slight gap is provided between the upper portion of the back-side nozzle half 23 and the joint surface of the front-side nozzle half 22. A longitudinally extending communication groove 26 is defined by the gap between the joint surface of the front-side nozzle half 22 and the upper portion of the back-side nozzle half 23 above the coating material reservoir 8, so that its lower end communicates with the coating material reservoir 8, and its upper end opens to the outside. Further, the upper end of the communication groove 26 is a nozzle port 27.

A coating material feed port 29 is defined in one or both of the side enclosures 28 to communicate with the coating material reservoir 25, so that a predetermined amount of a coating material is fed from the coating material feed port 29 to the coating material reservoir 25.

In such coating material supply nozzle 20 of the prior art example 1, when the predetermined amount of the coating material is fed from the coating material feed port 29 to the coating material reservoir 25, it is supplied from the coating material reservoir 25 to the communication groove 26 and discharged from the nozzle port 27. In this manner, the coating material is spread and applied onto a surface of a traveling substrate 30 at a uniform thickness.

In the coating material supply nozzle 20 of the prior art example 1, however, the following disadvantage is encountered: Because the coating material is supplied to the elongated coating material reservoir 25 from the coating material feed port or ports 29 provided in one or both of the enclosures 28 mounted at opposite ends of the elongated coating material reservoir 25, the coating material cannot be supplied uniformly in the lengthwise direction of the coating material reservoir 25 and cannot be applied to the substrate 30 at a thickness uniform in the widthwise direction. Further, there is a disadvantage that when the coating material feed bore 29 is provided in only one of the enclosures 28, the thickness of the applied coating material is gradually smaller in proportion to the increase in distance from the coating material feed bore 29, or varied complicatedly in a manner of thinner→thicker→thinner→thicker→thinner in proportion to the increase in distance from the coating material feed bore 29. When the coating material feed bores 29 are provided in both of the enclosures, respectively, there is a tendency that a joining mark is produced at a portion of the substrate corresponding to a central portion of the coating material reservoir 25 where flows of the coating material join each other, or the thickness of the applied coating material at such central portion is larger than those at opposite ends.

To solve the above-described disadvantages, in the prior art example 1, the coating material is supplied from only the coating material feed bore 29 provided in one of the enclosures 28, and the gap between the substrate 30 and the nozzle port 27 is set so that the gap size G1 on the side of the coating material feed bore 29 is larger, and the gap size G2 at the lengthwise opposite location is smaller, whereby the amount of coating material applied onto the substrate 30 is adjusted. However, it is complicated and difficult to regulate the gap sizes G1 and G2.

Conventionally, the coating material is supplied through a coating material feed bore 29a defined in a front-side nozzle half 22 into a coating material reservoir 25 at a location central in a lengthwise direction of the coating material reservoir 25 from a direction perpendicular to such lengthwise direction, as in a prior art example 2 shown in FIGS. 14a and 14b. However, the following disadvantage is encountered: It is impossible to moderate the influence of concentrated supplying of the coating material from the coating material feed bore 29a. For this reason, the thickness of the applied coating material at a portion corresponding to the coating material feed bore 29a is larger than those at other portions, and particularly, the thickness of the applied coating material is smaller at portions corresponding to opposite ends of the coating material reservoir 25. Further, the prior art example 2 suffers from a disadvantage that to exchange the coating supply nozzle 20 to another one, the coating supply nozzle 20 must be moved in a lengthwise direction and withdrawn. This is not of practical use.

Further, in the coating material nozzles 20 of the prior art examples 1 and 2 shown in FIGS. 12 to 14, the state of supplying of the coating material cannot be subsequently changed easily and regulated finely with respect to the coating material supply nozzle 20 once manufactured.

### SUMMARY OF THE INVENTION

Accordingly, it is an object of the present invention to provide a coating material supply nozzle, where in a coating material can be supplied to the coating material supply nozzle from a lengthwise end and more over, can be discharged uniformly over the entire length of a nozzle port and applied uniformly onto a substrate, and further, the state of supplying of the coating material can be changed and regulated easily.

To achieve the above object, according to the present invention, there is provided a coating material supply nozzle comprising a coating material reservoir where a coating material fed from the outside into a nozzle body□ and an elongated nozzle port, from which the coating material passed through a nozzle passage is discharged, wherein the nozzle further includes a coating material feed pipe mounted therein for feeding the coating material to extend in the coating material reservoir over the entire length, the coating material feed pipe being provided with at least one coating material feed bore for guiding the coating material within the coating material feed pipe into the coating material reservoir uniformly in a lengthwise direction of the coating material reservoir.

With such arrangement, the coating material can be supplied to the coating material supply nozzle from the lengthwise end by the coating material feed pipe and moreover, the coating material in the coating material feed pipe can be guided from the coating material feed bore into the coating material reservoir uniformly in the lengthwise direction of the coating material reservoir. In this manner, the coating material can be discharged uniformly over the entire length of the nozzle port and applied uniformly onto a substrate. Further, the state of supplying of the coating material can be changed and regulated by a simple operation of exchanging the coating material feed pipe to another one.

The above and other objects, features and advantages of the invention will become apparent from the following description of the preferred embodiment taken in conjunction with the accompanying drawings.

### BRIEF DESCRIPTION OF THE DRAWINGS

FIG. 1 is a partially cutaway perspective view of an embodiment of a coating material supply nozzle according to the present invention;

FIG. 2a is a sectional view taken along a line 2-2 in FIG. 1, and FIG. 2b is an enlarged sectional view of a coating material reservoir;

FIG. 3 is a partially cut away front view of the coating material supply nozzle shown in FIG. 1;

FIG. 4 is a side view of another example of a coating material feed pipe;

FIG. 5 is a side view showing a state in which a coating material is applied by the coating material supply nozzle shown in FIG. 1;

FIG. 6 is a plan view of the coating material supply nozzle shown in FIG. 5;

FIG. 7 is a characteristic diagram showing the comparison between coating material uniform-coating performances of the nozzle according to the present invention and nozzles of prior art examples;

FIG. 8 is a characteristic diagram similar to FIG. 7;

FIG. 9 is a characteristic diagram similar to FIG. 7;

FIG. 10 is a characteristic diagram showing a coating material uniform-coating performance of another example of the present invention;

FIG. 11 is a characteristic diagram showing a coating material uniform-coating performance of a further example of the present invention;

FIG. 12 is a vertical sectional view of a conventional coating material supply nozzle;

FIG. 13 is a plan view showing a state in which a coating material is applied by the coating material supply nozzle shown in FIG. 12; and

FIG. 14a is a front view of another example of a conventional coating material supply nozzle, and FIG. 14b is a sectional view taken along a line b-b in FIG. 14a.

### DESCRIPTION OF THE PREFERRED EMBODIMENT

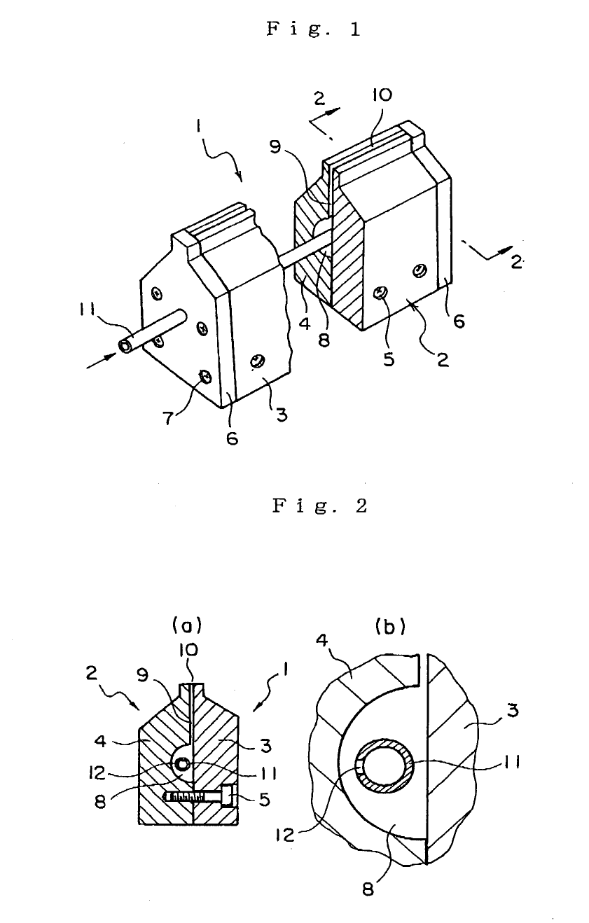

The present invention will now be described by way of an embodiment with reference to FIGS. 1 to 11.

Referring to FIG. 1, an embodiment of a coating material supply nozzle 1 according to the present invention is shown. The supply nozzle 1 includes a nozzle body 2 comprising a longer nozzle half 3 on a front side and a nozzle half 4 on a back side, which are integrally coupled to each other by a bolt 5. A side enclosure 6 is secured by bolts 7 to each of the front-side nozzle half 3 and the back-side nozzle half 4 coupled to each other. A joint surface of the front-side nozzle half 3 is formed into a flat shape, and a coating material reservoir 8 semicircular in section is defined in a joint surface of the back-side nozzle half 4 at a location intermediate in a direction of the height thereof to extend in a lengthwise direction.

In the present embodiment, the back-side nozzle half 4 is formed, so that the thickness (lateral distance) of an upper portion above the coating material reservoir 8 is slightly smaller than the thickness of a lower portion below the coating material reservoir 8. In a state in which the front-side nozzle half 3 and the back-side nozzle half 4 have been coupled to each other, a slight gap. is provided between the upper portion of the back-side nozzle half 4 and the joint surface of the front-side nozzle half 3. A longitudinally extending nozzle passage 9 is defined by the gap between the joint surface of the front-side nozzle half 3 and the upper portion of the back-side nozzle half 4 above the coating material reservoir 8, so that its lower end communicates with the coating material reservoir 8, and its upper end opens to the outside. The upper end of the nozzle passage 9 is an elongated nozzle port 10 which opens into an upper surface of the nozzle body 2.

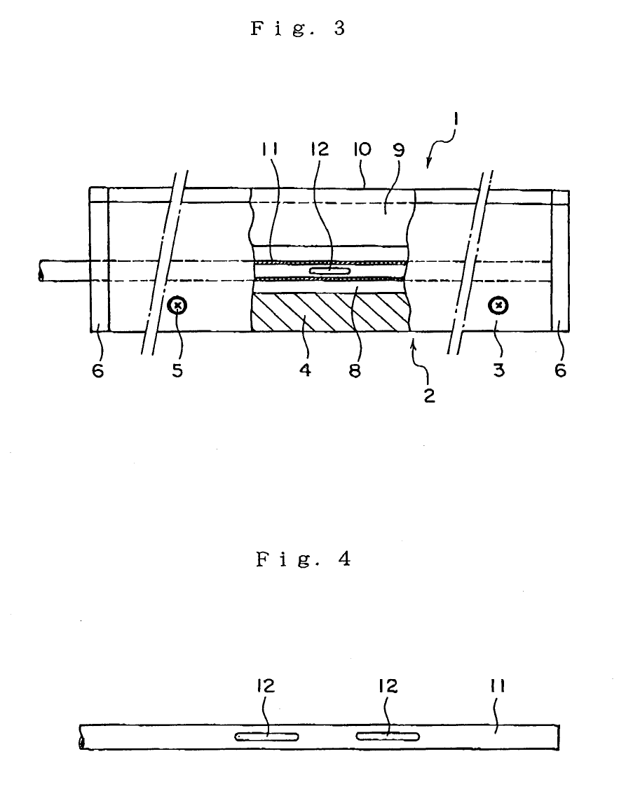

Further, in the present embodiment, a coating material feed pipe 11 for feeding a coating material is mounted in the nozzle body 2 to extend over the entire length of the coating material reservoir 8. More specifically, the coating material feed pipe 11 is mounted, so that it extends through one of the side enclosures 6 and through a substantially central portion of the coating material reservoir 8 to reach the other side enclosure 6, as shown in FIG. 3. Further, at least one coating material feed bore 12 is provided in the coating material feed pipe 11 for guiding the coating material in the coating material feed pipe 11 into the coating material reservoir 8 uniformly in a lengthwise direction. In the embodiment shown in FIG. 3, the one coating material feed bore 12 is provided in the coating material feed pipe 11 at a lengthwise center of the coating material reservoir 8. It is preferable that the coating material feed bore 12 opens into the coating material feed pipe 11 at such a circumferential location that an ink fed does not flow directly into the nozzle passage 9, as shown in FIG. 2. In this case, the thickness of ink coated can be uniformized. Namely, a coating material flow path defined between the coating material feed pipe 11 and the coating material reservoir can exhibit a flow rate uniformizing effect by changing the direction of flowing of the coating material and varying the sectional area, thereby effectively conducting the uniformization of the coating material. In the embodiment shown in FIGS. 2 and 3, the coating material feed bore 12 opens at a location where it faces to a deepest portion of a recessed side of the coating material reservoir 8. Further, it is of course that the number of the coating material feed bores 12 provided in the coating material feed pipe 11 may be two or more, as shown in FIG. 4, or the sectional shapes of the coating material feed bore 12 and the coating material feed pipe 11 may be changed, or a plurality of the coating material feed pipes 11 may be placed in parallel to one another, depending on coating conditions such as the nature of the coating material, e.g., the viscosity, the amount of coating material fed, the length of the nozzle port 10 and the like.

A process for coating the coating material using the above-described coating material supply nozzle 1 will be described below.

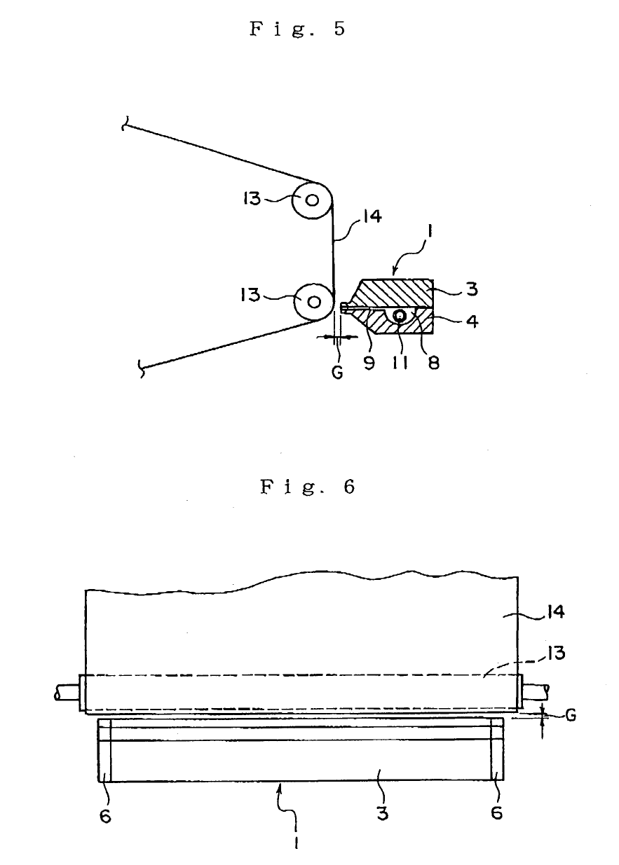

In the present embodiment, the nozzle port 10 in the coating material supply nozzle 1 is placed in parallel to a continuous substrate 14 traveling through guide rolls 13, 13, and a gap G between the substrate 14 and the nozzle port 10 is provided uniformly over the entire length of the coating material supply nozzle 1, as shown in FIGS. 5 and 6.

Then, the substrate 14 is allowed to travel at a predetermined speed and at the same time, a predetermined amount of the coating material is fed into the coating material feed pipe 11 from a lengthwise end with respect of the coating material supply nozzle 1. The coating material in the coating material feed pipe 11 is fed into the coating material reservoir 8 through the coating material feed bore 12 disposed at the lengthwise center of the coating material reservoir 8, and the flow rate of the coating material is adjusted uniformly in the lengthwise direction of the coating material reservoir 8. Further, the coating material feed bore 12 opens into the coating material feed pipe 11 at the location where it faces to the deepest portion of the recessed side of the coating material reservoir 8 and hence, while the coating material is passed through a flow path defined between an outer peripheral surface of the coating material feed pipe 11 and an inner peripheral surface of the coating material reservoir 8, i.e., a flow path where the direction of flowing of the coating material is changed and the sectional area is changed, the coating material is subjected to a change in flow course and to an increase and decrease in volume, and it then reaches the nozzle passage 9. While the coating material is passed through the nozzle passage 9, it is subjected to the uniformization of flow rate attributable to the above-described flow path, whereby the flow rate in the lengthwise direction of the coating material reservoir 8 is uniformized. In this manner, the coating material is passed through the nozzle passage 9 and discharged from the nozzle port 10 uniformly over the entire length thereof, and thus applied uniformly to the substrate 14.

In the present embodiment, by changing the construction of the coating material feed pipe 11, namely, changing the location of opening and the number of the coating material feed bores 12, or changing the sectional shapes of the coating material feed bore 12 and the coating material feed pipe 11, or changing the number of the coating material feed pipes 11, depending on the coating conditions such as the nature of the coating material, e.g., the viscosity, the amount of coating material fed, the length of the nozzle port 10 and the like, the state of feeding of the coating material can be changed regulated without changing of the construction other that the construction of the coating material feed pipe 11 in the coating material supply nozzle 1.

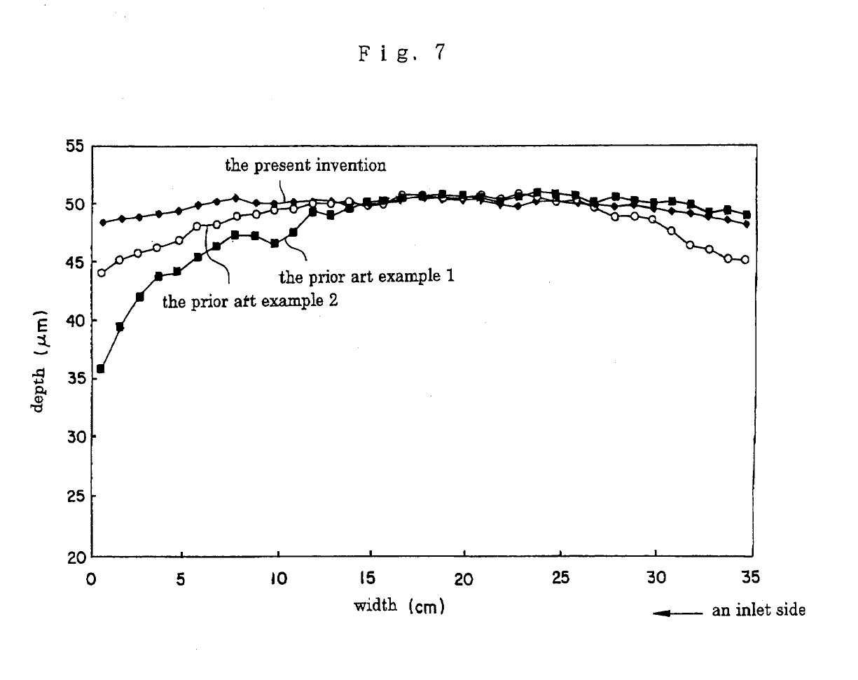

The performance of uniform coating of the coating material according to the present invention will be described with reference to FIG. 7 to 9, while comparing it with the prior art examples.

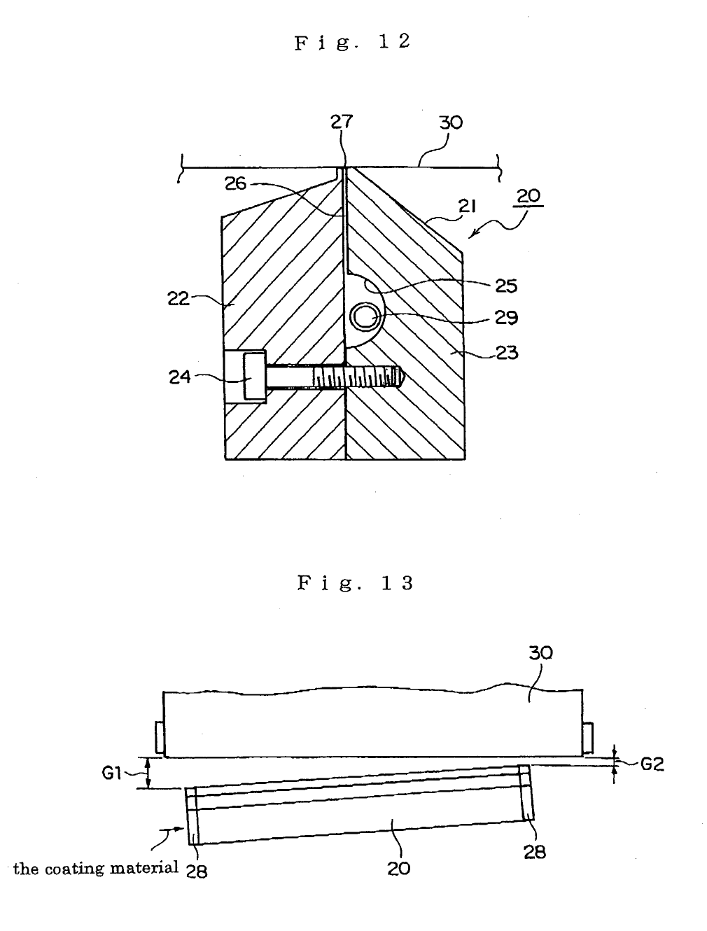

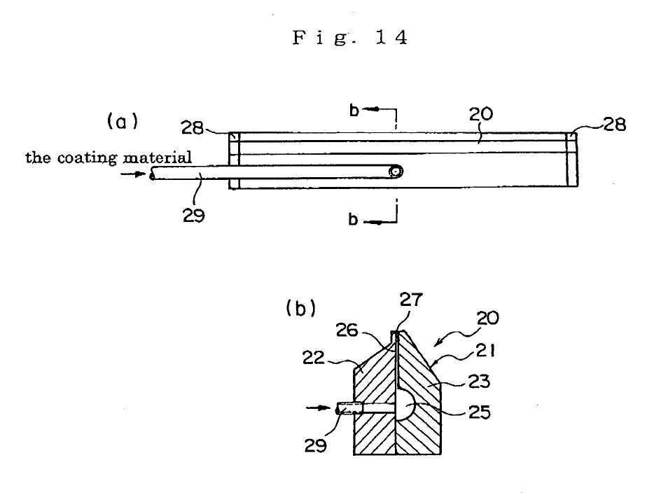

FIG. 7 shows the thicknesses of coating materials coated to the substrates 14 and 30 by the coating material supply nozzle 1 according to the embodiment shown in FIG. 1 and the coating material supply nozzles 20 of the prior art examples 1 and 2 shown in FIGS. 12 and 14 for comparison with each other. The coating materials were fed and coated leftwards from the right side in FIG. 7 under coating conditions which will be described below. The inside diameter of the coating material feed pipe 11 which was a component for only the coating material supply nozzle 1 was 10 mm; the coating material feed bore 12 was of an elliptic shape having a width of 6 mm and a length of 15 mm; the nozzle ports 10 and 27 which were other supply components for the nozzle 1 and the size of the prior art nozzles was set at a length of 35 mm and a width of 190 μm; the gap G was set such that (G1+G2) /2 was 200 μm; and the viscosity of the coating material was set at 2,400 mPa··S. As shown in FIG. 7, the supply nozzle according to the present invention is of a structure in which the coating material is fed from the coating material feed bore 12 disposed in the coating material feed pipe 11 at the lengthwise center of the coating material reservoir 8 and hence, a variation in thickness of the applied coating material was suppressed to the order of 2.5 μm at the maximum over the entire length of the nozzle port 10 and thus, the uniform coating was achieved. On the other hand, in the prior art example 1 shown in FIG. 12, the supply nozzle is of a structure in which the coating material is supplied from a coating material feed bore 29 disposed at a lengthwise end of a coating material reservoir 25. For this reason, the thickness of the applied coating material was larger at an inlet side and smaller at a leading end, and a variation in thickness amounted to 15 μm at the maximum and hence, the uniform coating was not realized. In the prior art example 1 shown in FIG. 14, the supply nozzle is of a structure in which the coating material is supplied through a coating material feed bore 29a into a coating material reservoir 25 at a lengthwise central position from a direction perpendicular to the lengthwise direction of the coating material reservoir 25. For this reason, the thickness of the applied coating material was larger at a central inlet side and smaller at opposite ends, and the average thickness was 50 μm, with a variation in thickness being amounted to 7 μm at the maximum (a variation rate =14%), and hence, the uniform coating was not realized.

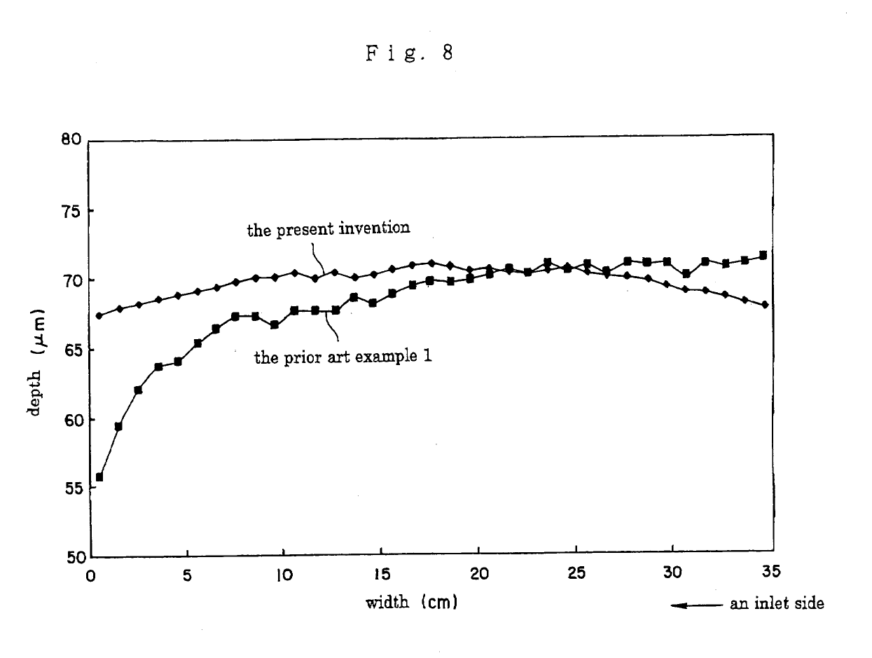

FIG. 8 shows the thicknesses of coating materials coated to the substrates under coating conditions similar to those shown in FIG. 7, except that the size of the nozzle ports 10 and 27 as supply components of the nozzles according to the present invention and in the prior art example 1 was set at a length of 35 mm and a width of 590 μm; the gap G was set such that (G1+G2)/2 was 400 μm; and the viscosity of the coating material was set at 4,000 mPa·S. Even in FIG. 8, according to the present invention, a variation in thickness of the applied coating material was suppressed to the order of 2.5 μm at the maximum over the entire length of the nozzle port 10 and hence, the uniform coating was achieved, as in FIG. 7. In the prior art example 1, the thickness of the applied coating material was larger at the inlet side and smaller at the leading end, and a variation in thickness amounted to 15 μm at the maximum and hence, the uniform coating was not realized.

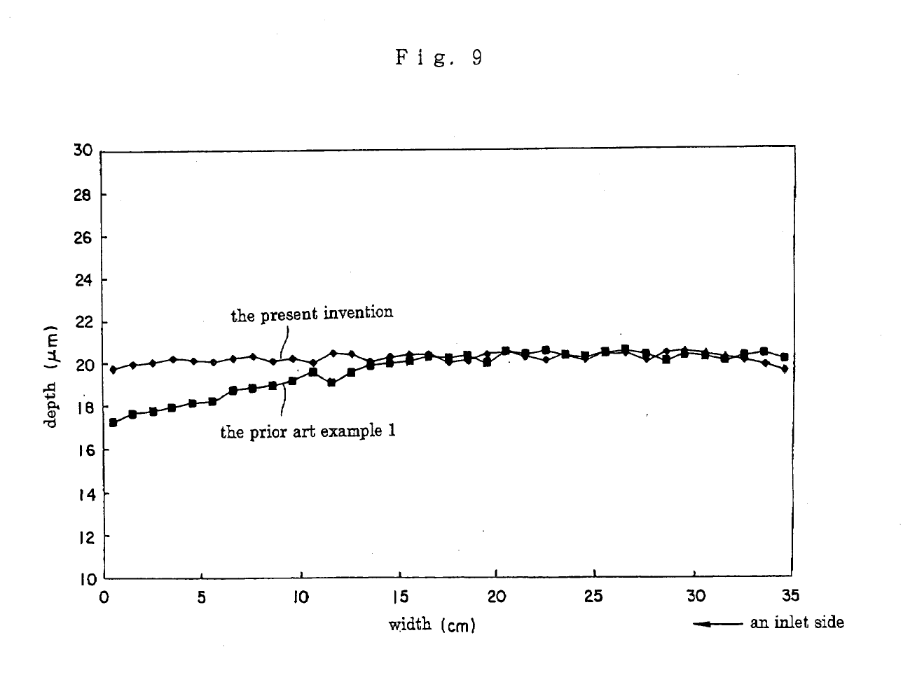

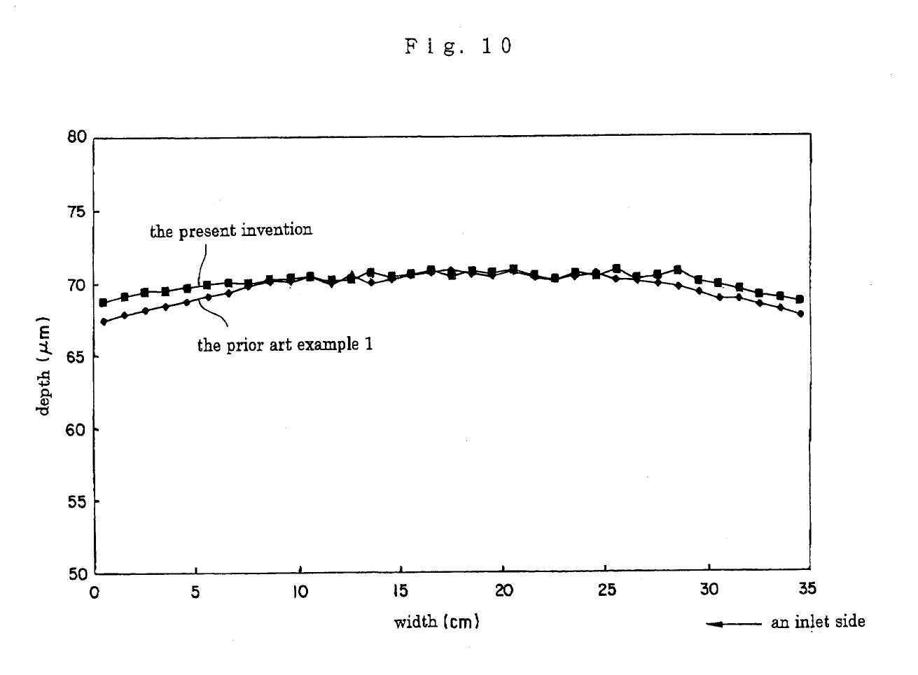

FIG. 9 shows the thicknesses of coating materials coated to the substrates under coating conditions similar to those shown in FIG. 7, except that the size of the nozzle ports 10 and 27 as supply components of the nozzles according to the present invention and in the prior art example 1 was set at a length of 35 mm and a width of 190 μm; the gap G was set such that (G1+G2)/2 was 100 μm; and the viscosity of the coating material was set at 980 mPa·S. Even in FIG. 9, according to the present invention, a variation in thickness of the applied coating material was suppressed to the order of 1.0 μm at the maximum over the entire length of the nozzle port 10 and hence, the uniform coating was achieved, as in FIG. 7. In the prior art example 1, the thickness of the applied coating material was larger at the inlet side and smaller at the leading end, and a variation in thickness amounted to 3 μm at the maximum and hence, the uniform coating was not realized.

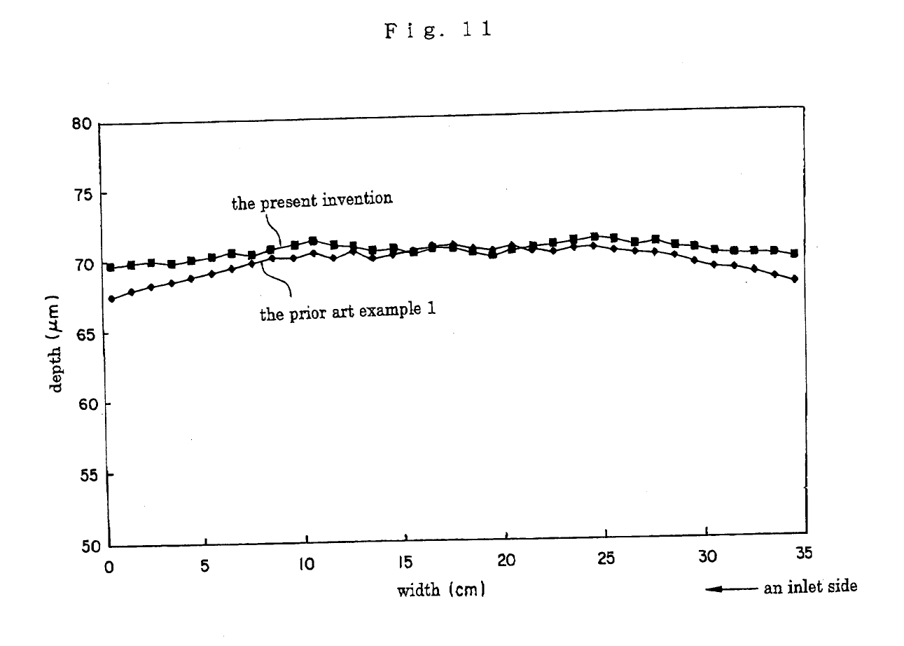

The performance of uniform coating of the coating material according to the present invention will be described with respect to various examples of the coating material feed bores 12 with reference to FIGS. 10 and 11.

FIG. 10 shows the thickness in the example of the present invention shown in FIG. 7 (shown by a black rhombic shape) and the thickness in an example of the present invention in which the coating material feed bore 12 was of an elliptic shape with a width of 6 mm and length of 30 mm (shown by a black quadrilateral shape) As shown in FIG. 10, in any of the examples of the present invention, the uniform coating was achieved over the entire length of the nozzle port 10. It was also found that when the length of the coating material feed bore 12 is larger, the uniformity tends to be higher.

FIG. 11 shows the thickness in the example of the present invention shown in FIG. 7 (shown by a black rhombic shape) and the thickness in an example of the present invention in which the two coating material feed bores 12 having the same size as in FIG. 7 are provided at locations spaced laterally apart from the center of the coating material reservoir 8 (shown by a black quadrilateral shape). As shown in FIG. 11, in any of the examples of the present invention, the uniform coating was achieved over the entire length of the nozzle port 10. It was also found that when the two coating material feed bores 12 are provided, the uniformity tends to be higher.

Therefore, according to the examples of the present invention, the coating material can be supplied from the lengthwise end to the coating material supply nozzle 1 by the coating material feed pipe 11 and moreover, the coating material in the coating material feed pipe 11 can be guided from the coating material feed bore 12 into the coating material reservoir 8 uniformly in the lengthwise direction of the coating material reservoir 8. This ensures that the coating material can be discharged uniformly over the entire length of the nozzle port 10 and applied uniformly to the substrate 14.

Although the embodiments of the present invention have been described in detail, it will be understood that the present invention is not limited to the above-described embodiments, and various modifications in design may be made without departing from the spirit and scope of the invention defined in claims.

[Effect of the Invention]

As discussed above, the coating material supply nozzle according to the present invention provides the following effects: The coating material can be supplied to the coating material supply nozzle from the lengthwise end and moreover, can be discharged uniformly over the entire length of the nozzle port and applied uniformly onto the substrate. Further, the state of supplying of the coating material can be changed and regulated easily.

What is claimed is

1. A coating material supply nozzle comprising a coating material reservoir where a coating material fed from the outside into a nozzle body, and an elongated nozzle port, from which the coating material passed through a nozzle passage is discharged, wherein
said nozzle further includes a coating material feed pipe mounted therein for feeding the coating material to extend in said coating material reservoir over the entire length, said coating material feed pipe being provided with at least one coating material feed bore for guiding the coating material within the coating material feed pipe into the coating material reservoir uniformly in a lengthwise direction of said coating material reservoir.
